(19) United States
(12) Patent Application Publication
(10) Pub. No.: US 2021/0234817 A1
(43) Pub. Date: Jul. 29, 2021

(54) INFORMATION PROCESSING SYSTEM AND NON-TRANSITORY COMPUTER READABLE MEDIUM STORING PROGRAM

(71) Applicant: FUJI XEROX CO., LTD., Tokyo (JP)

(72) Inventor: Jiahao DAI, Kanagawa (JP)

(73) Assignee: FUJI XEROX CO., LTD., Tokyo (JP)

(21) Appl. No.: 16/919,075

(22) Filed: Jul. 1, 2020

(30) Foreign Application Priority Data
Jan. 27, 2020 (JP) 2020-011221

(51) Int. Cl. H04L 12/58; G06F 3/0481; H04L 29/08

(52) U.S. Cl. CPC H04L 51/046; G06F 3/0481; G06F 3/04847; H04L 51/08; H04L 67/24

(57) ABSTRACT

An information processing system includes a processor configured to create and manage an exchange space in which a post of a communication message is received and accumulated, and manage relation information indicating a relation between the exchange spaces, and, in a case where a new exchange space is created, specify a relevant exchange space having a specific relation with the new exchange space among existing exchange spaces, perform weighting on setting information of the relevant exchange space based on the relation between the relevant exchange space and the new exchange space, and set the new exchange space based on the weighted setting information of each relevant exchange space.

### CROSS-REFERENCE TO RELATED APPLICATIONS

This application is based on and claims priority under 35 USC 119 from Japanese Patent Application No. 2020-011221 filed Jan. 27, 2020.

### BACKGROUND

### (i) Technical Field

The present invention relates to an information processing system and a non-transitory computer readable medium storing a program.

### (ii) Related Art

In a case where a new framework (referred to as an “exchange space” below) in which specific members participate is created using a communication tool such as a chat system and an electronic bulletin board, it is required to set appropriate participants or appropriate access permissions. In order to reduce such troubles, the selection of members to participate in a new exchange space is supported using various kinds of information.

JP2003-216785A discloses a member selection support system that saves history information of transmission and reception of messages of users in an electronic communication system, calculates the degree of conformity of each user to a role in a group activity characterized by the history information, and selects an appropriate member who forms a new group from a predetermined set of users.

JP2009-140029A discloses an apparatus that receives an input of selection conditions for members participating in a project, extracts a person who matches the selection condition, as a candidate, from an in-house database in which pieces of attribute information associated with persons as selection target are recorded, calculates the degree of intimacy for all candidates based on the frequency of shared activities with a project manager, and displays the degree of intimacy in a graph.

### SUMMARY

In a case where an exchange space related to a specific subject is created, exchange spaces with similar setting contents may be created. In such a case, in order to create a new exchange space, an existing exchange space is duplicated, or a template created in advance is used. However, while the exchange space is repeatedly created, the setting contents handed over from the existing exchange space or the template may deviate from the actual conditions of the new exchange space to be created.

Aspects of non-limiting embodiments of the present disclosure relate to an information processing system and a non-transitory computer readable medium storing a program that supports the creation of a new exchange space by reflecting the status of an existing exchange space in a case where the exchange space related to a specific subject is repeatedly created.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to create and manage an exchange space in which a post of a communication message is received and accumulated, and manage relation information indicating a relation between the exchange spaces, and, in a case where a new exchange space is created, specify a relevant exchange space having a specific relation with the new exchange space among existing exchange spaces, perform weighting on setting information of the relevant exchange space based on the relation between the relevant exchange space and the new exchange space, and set the new exchange space based on the weighted setting information of each relevant exchange space.

### BRIEF DESCRIPTION OF THE DRAWINGS

Exemplary embodiment(s) of the present invention will be described in detail based on the following figures, wherein:

FIG. 1 is a diagram illustrating a functional configuration of a server in an information processing system according to an exemplary embodiment;

FIG. 2 is a diagram illustrating a configuration example of a computer that realizes the server;

FIG. 3 is a diagram illustrating a configuration example of a terminal apparatus;

FIG. 4 is a flowchart illustrating an operation of the server in a case of creating a new exchange space;

FIG. 5 is a diagram illustrating an example of a relation between a new exchange space and a relevant exchange space;

FIG. 6 is a diagram illustrating a scene in which messages are transmitted and received in an exchange space;

FIG. 7 is a diagram illustrating an example of a priority item of a development project for each version illustrated in FIG. 5;

FIG. 8 is a diagram illustrating an example of a screen for presenting attributes of a template of a new exchange space;

FIG. 9 is a diagram illustrating an example of a screen for presenting initial information of anew generated exchange space; and

FIG. 10 is a diagram illustrating an example of a screen for recommending a participant candidate in a new exchange space.

### DETAILED DESCRIPTION

Hereinafter, exemplary embodiments of the present invention will be described in detail with reference to the accompanying drawings. In the exemplary embodiment, an information processing system is realized by including a server that provides an exchange space and a terminal apparatus that accesses the exchange space to post or view a message, transfer a data file, and the like. The information processing system may be configured in various scales. For example, the server may be a cloud server on the Internet or the like, or may be a local server. In the former case, the terminal apparatus is connected to the server via the Internet. In the latter case, the terminal apparatus is connected to the server via a Local Area Network (LAN).

Functional Configuration of Server

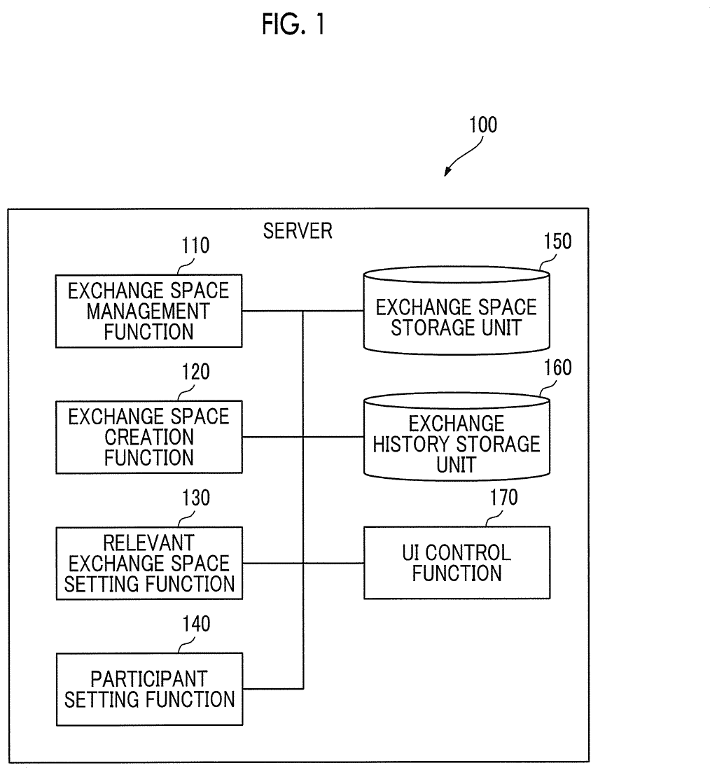

FIG. 1 is a diagram illustrating a functional configuration of a server in the information processing system according to the exemplary embodiment. A server 100 includes an exchange space management function 110, an exchange space creation function 120, a relevant exchange space setting function 130, a participant setting function 140, an exchange space storage unit 150, an exchange history storage unit 160, and a UI control function 170. The above functions may be realized in a single server machine or may be realized by being distributed in a plurality of servers.

The exchange space management function 110 is a function of managing the created exchange space. The exchange space management function 110 is a function of managing relation information indicating a relation between exchange spaces as management targets. The relation information is information indicating a set of a plurality of exchange spaces that have been set as relevant exchange spaces by the relevant exchange space setting function 130.

The exchange space creation function 120 is a function of creating a new exchange space in response to a request received from a terminal apparatus 200 and supporting a setting operation for the created new exchange space. In the exchange space creation function 120, a new exchange space is set based on setting information of the relevant exchange space, as a support function in a case of creating the new exchange space. The relation between the new exchange space and the relevant exchange space will be described later, but a plurality of relevant exchange spaces may be provided for one new exchange space. Each relevant exchange space is weighted in accordance with the relation with the new exchange space. The influence on the setting of the new exchange space varies depending on a weight value assigned to each relevant exchange space. Specifically, setting information of the relevant exchange space to which a large weight value is assigned strongly influences the setting of a new exchange space.

One type of the setting information of the relevant exchange space is information of participants in the relevant exchange space. In a case where a new exchange space is created by the exchange space creation function 120, a participant candidate for the new exchange space is specified based on the information of the participants in the relevant exchange space. Each participant of the relevant exchange space is weighted in accordance with, for example, the activity status in the relevant exchange space. The participant candidate in the new exchange space is specified based on the weight value assigned to the relevant exchange space and a weight value assigned to each participant in each relevant exchange space. The participant setting function 140 performs weighting on each participant in the relevant exchange space and selects the participant candidate for a new exchange space.

The relevant exchange space setting function 130 is a function of, in a case where a new exchange space is created by the exchange space creation function 120, specifying a relevant exchange space being an exchange space having a specific relation with the new exchange space among the existing exchange spaces. The setting of the relevant exchange space is reflected in the setting of the new exchange space. Examples of the exchange space as the relevant exchange space include an exchange space created with a subject identical to the subject of a new exchange space, an exchange space created with an identical template, and an exchange space created by using the existing identical exchange space. The subject of an exchange space is, for example, the field or object of information that is exchanged or shared in the exchange space. The subject information is recorded as, for example, a title or meta information of the exchange space.

The relevant exchange space setting function 130 is a function of performing weighting on the setting of the specified relevant exchange space based on the relation between the relevant exchange space and the new exchange space. With the weighting, the degree to which the setting of the relevant exchange space is reflected in the new exchange space is controlled. In a case where a plurality of relevant exchange spaces are provided, the degree of an influence on the setting of the new exchange space is controlled in accordance with the weight value of each relevant exchange space. As a weighting method, various methods may be taken in accordance with the attributes of the relevant exchange space, or the content and the like of the relation between the new exchange space and the relevant exchange space, which has been considered in order to specify the relevant exchange space. As an example, in a case where a plurality of relevant exchange spaces are repeatedly created with a subject identical to a subject of the new exchange space, it is considered that weighting is performed such that a greater weight value is assigned to the newer relevant exchange space (relevant exchange space created later) among the plurality of relevant exchange spaces. As another example, it is considered that weighting is performed such that a greater weight value is assigned to the relevant exchange space in which the similarity of the attributes is higher among a plurality of relevant exchange spaces created with a subject identical to the subject of a new exchange space. It is considered that weighting is performed such that a weight value larger than a weight value of an exchange space created using an identical template to a new exchange space is assigned to the relevant exchange space created with a subject identical to the subject of the new exchange space.

The participant setting function 140 is a function of specifying a participant candidate in a new exchange space. The participant candidate in a new exchange space is specified based on the information of participants in the relevant exchange space. In the participant setting function 140, the attribute of a participant candidate in a new exchange space is set based on the attribute of a participant in the relevant exchange space. For example, a participant who has participated as a leader in a relevant exchange space in which an organization or a project is set as a subject is considered as a participant candidate for a leader in a new exchange space.

In the participant setting function 140, weighting is performed on each participant in a relevant exchange space in accordance with an activity status in the relevant exchange space. Specifically, a large weight value is assigned to a participant who has been active in the relevant exchange space. For example, it is considered that weighting is performed such that a greater weight value is assigned to a participant who has a large number of posted communication messages in the relevant exchange space. Further, it is considered that weighting is performed such that a greater weight value is assigned to a participant who has a larger number of times of viewing a data file which is uploaded to the relevant exchange space and shared by each participant.

In the participant setting function 140, the participant candidate in a new exchange space is specified based on the weight value assigned to the relevant exchange space and the weight value assigned to each participant in each relevant exchange space. Specifically, for example, in a case where a value (referred to as “reliability” of a participant below) obtained by calculation using the weight value of the relevant exchange space and the weight value of a participant exceeds a preset threshold value, it is considered that the participant is set as a participant candidate for a new exchange space.

The exchange space storage unit 150 is a storage device that holds data of an existing exchange space managed by the exchange space management function 110. The exchange space storage unit 150 is realized by, for example, a Solid State Drive (SSD) or a magnetic disk device. A storage server or the like outside the server 100 may be used as the exchange space storage unit 150.

The exchange history storage unit 160 is a storage device that holds a history of exchange activities in an existing exchange space managed by the exchange space management function 110. The exchange activity in the exchange space is, for example, posting of a message, viewing, and uploading, downloading, and the like of data. The exchange history storage unit 160 is realized by, for example, a Solid State Drive (SSD) or a magnetic disk device. A storage server or the like outside the server 100 may be used as the exchange history storage unit 160.

The UI control function 170 is a function of generating a user interface (UI) screen and providing the user interface screen to the terminal apparatus 200 connected to the server 100. The UI screen includes, for example, a screen for performing an exchange activity in an exchange space, a screen for creating a new exchange space, and a screen for changing the setting of an existing exchange space. The UI screen may be created in the HyperText Markup Language (HTML) and may be displayed on a display device of the terminal apparatus 200 using a Web browser or the like.

Hardware Configuration of Server 100

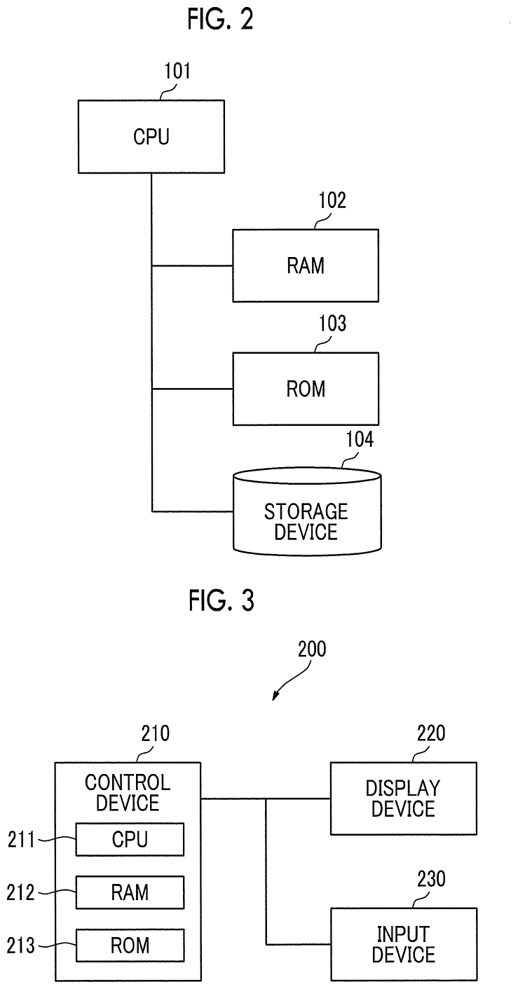

FIG. 2 is a diagram illustrating a configuration example of a computer that realizes the server 100. A computer that realizes the server 100 includes a Central Processing Unit (CPU) 101 as a calculation unit, and a Random Access Memory (RAM) 102, a Read Only Memory (ROM) 103, and a storage device 104 which are storage units. The RAM 102 is a main storage device (main memory) and is used as a work memory in a case where the CPU 101 performs a calculation process. The ROM 103 may store programs and data such as setting values prepared in advance. The CPU 101 may directly read programs and data from the ROM 103 and perform processing. The storage device 104 is a unit that saves programs and data. Programs are stored in the storage device 104, and the CPU 101 reads the program stored in the storage device 104 into the main storage device and executes the program. The storage device 104 stores and saves the result of the process performed by the CPU 101. For example, a magnetic disk device or a Solid State Drive (SSD) is used as the storage device 104.

In a case where the server 100 is realized by the computer illustrated in FIG. 2, for example, the CPU 101 executes a program to realize the exchange space management function 110, the exchange space creation function 120, the relevant exchange space setting function 130, the participant setting function 140, and the UI control function 170 described above. For example, the exchange space storage unit 150 and the exchange history storage unit 160 are realized by the storage device 104.

Configuration of Terminal Apparatus 200

FIG. 3 is a diagram illustrating a configuration example of the terminal apparatus 200. The terminal apparatus 200 includes a control device 210, a display device 220, and an input device 230. The terminal apparatus 200 is realized by an information processing apparatus such as a personal computer or a smartphone. The configuration illustrated in FIG. 3 is just an example, and the configuration of the terminal apparatus 200 is not limited to the configuration illustrated in FIG. 3. For example, the terminal apparatus may include a storage device that holds various types of data used in processing and processing results, and a peripheral device that realizes various functions controlled by the control device 210.

The control device 210 is a device that controls the terminal apparatus 200, and includes a CPU 211, a RAM 212, and a ROM 213. The RAM 212 is a main storage device and is used as a work memory in a case where the CPU 211 performs a calculation process. The ROM 213 stores programs and data such as setting values prepared in advance, and the CPU 211 reads the programs and data from the ROM 213 and performs processing. The CPU 211 may read a program stored in a storage device (not illustrated) into the RAM 212 and perform processing.

The display device 220 is a device that displays screens such as an operation screen and an information presentation screen. The display device 220 displays the UI screen acquired from the server 100. For example, a liquid crystal display or the like is used as the display device 220.

The input device 230 is a device that receives an input operation by a user. The input device 230 receives an operation performed by the user in accordance with the operation screen such as a UI screen, which is displayed on the display device 220. For example, a device such as a keyboard or a mouse is used as the input device 230. A touch panel as a user interface, in which a touch sensor is used as the input device 230 and is combined with a liquid crystal display as the display device 220 may be configured.

The terminal apparatus 200 receives an operation of the input device 230 by a user, performs a connection to the server 100 to acquire a UI screen, and displays the acquired UI screen on the display device 220. The terminal apparatus 200 receives an operation on the input device 230 by the user on the UI screen, and creates a new exchange space or changes the setting of an exchange space. The terminal apparatus 200 receives an operation on the UI screen by the user, accesses the designated exchange space, and performs processing such as posting and displaying of a message and uploading and downloading of data.

Operation in Case where Server 100 Creates New Exchange Space

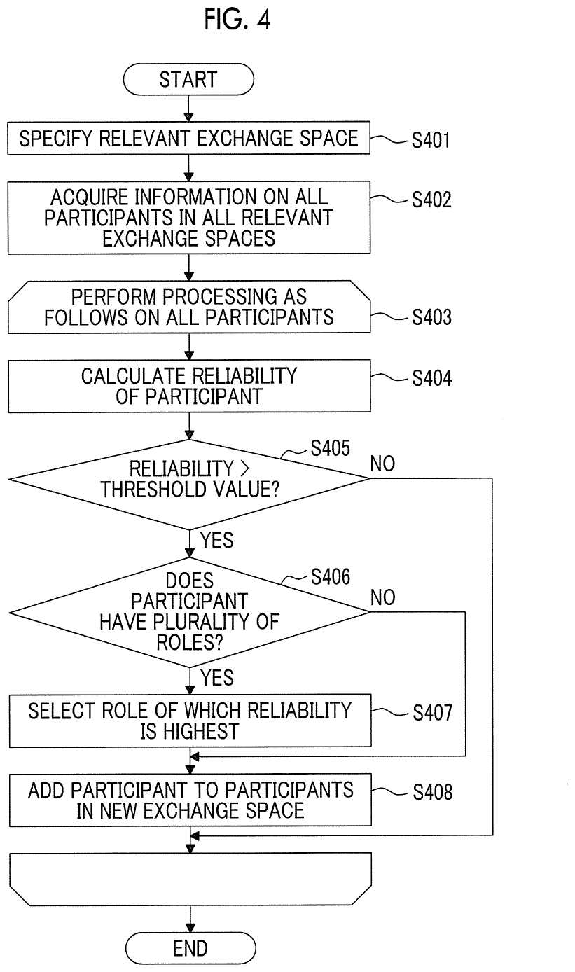

FIG. 4 is a flowchart illustrating an operation of the server 100 in a case of creating a new exchange space. In a case where the server 100 receives a command to create a new exchange space, the server 100 specifies a relevant exchange space for the new exchange space with the relevant exchange space setting function 130 (S401). At this time, weighting is also performed on each relevant exchange space. Then, the server 100 acquires the information on all the participants in the specified relevant exchange space by the participant setting function 140 (S402). At this time, weighting is also performed on each participant. With the participant setting function 140, the server 100 performs processing as follows on all the participants in the relevant exchange space to determine whether or not all the participant are to be set as participant candidates (S403).

Firstly, the server 100 pays attentions to one participant and calculates the reliability of the participant under attentions by the participant setting function 140 (S404). A calculation method of the reliability may be set based on the attributes of the new exchange space and the relevant exchange space, and is not particularly limited. A specific example of the calculation method of the reliability will be described later.

In a case where the calculated reliability is higher than a predetermined threshold value (YES in S405), the server 100 determines whether or not the participant under attentions has a plurality of roles in one or a plurality of relevant exchange spaces. In a case where the participant under attentions has only one role (NO in S406), the server 100 adds the participant under attentions to participant candidates for a new exchange space, as the above role (S408). In a case where the participant under attentions has a plurality of roles (YES in S406), the server 100 selects the role having the highest reliability among the roles (S407), and adds the participant under attentions to the participant candidates for a new exchange space, as the selected role (S408).

Here, the role in the relevant exchange space is defined based on the attributes of a participant in the relevant exchange space. Specifically, there is no limitation on what is set as a role. For example, a manager or an observer of the relevant exchange space, and the leader or a general member of an organization or a project related to the subject of the relevant exchange space may be defined as roles. As an example, a case as follows is considered. In this case, a plurality of relevant exchange spaces have been created for one subject, and there is a participant who participates in one relevant exchange space as the leader of an organization related to a subject and participates in another one relevant exchange space as a general member of an organization related to a subject. In a case where the reliability in the relevant exchange space in which the participant participates as the leader is higher than the reliability in the relevant exchange space in which the participant participates as the general member, the participant is set as a participant candidate as the leader for a new exchange space in S407.

### Application Example

Next, a specific application example of the exemplary embodiment will be described. Here, assumed is a case where a development project of software (SW) is a subject, an exchange space is created for each version of software, with members participating in the development as participants.

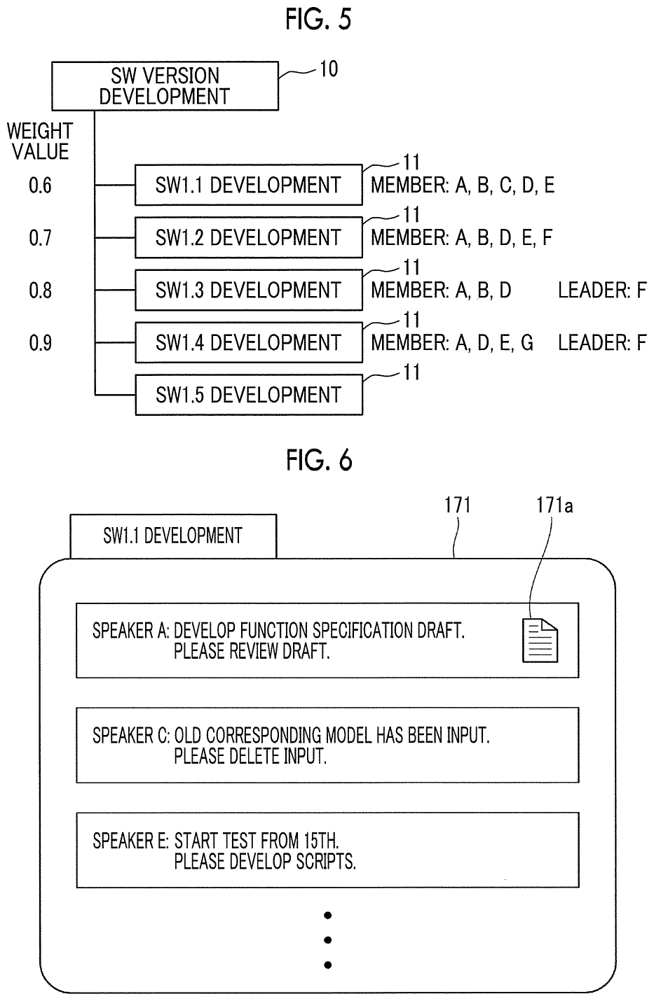

FIG. 5 is a diagram illustrating a relation between a new exchange space and a relevant exchange space in the application example. In the example illustrated in FIG. 5, the relation between exchange spaces is shown in a tree structure in which child nodes 11 referred to as “SW1.1 development” to “SW1.5 development” are connected to a parent node 10 referred to as “SW version development”. The parent node 10 indicates the subject of this project, and each child node 11 indicates an exchange space created based on the subject of the parent node 10. Regarding the name of the child node 11, for example, “SW1.1 development” indicates that the exchange space is an exchange space created for a development project of software version 1.1. Each exchange space is created in order from the exchange space corresponding to the child node 11 located at the top in FIG. 5.

Thus, in the application example illustrated in FIG. 5, in the software development referred to as “SW version development”, exchange spaces are created for development projects of version 1.1 to version 1.5, respectively. Each development project is created in order of version numbers from version 1.1, and an exchange space for the last version 1.5 is a new exchange space created this time. The exchange spaces for version 1.1 to version 1.4 are relevant exchange spaces based on a condition of the identical subject (development project of the identical software), respectively.

With the relevant exchange space setting function 130, a greater weight value is assigned to a relevant exchange space having the later creation time. Because a relevant exchange space for a newer version is created later, as illustrated in FIG. 5, a weight value “0.9” is assigned to the relevant exchange space for version 1.4, a weight value “0.8” is assigned to the relevant exchange space for version 1.3, a weight value “0.7” is assigned to the relevant exchange space for version 1.2, and a weight value “0.6” is assigned to the relevant exchange space for version 1.1.

In FIG. 5, a participant of the corresponding relevant exchange space is added to the child node 11 representing each relevant exchange space. In the description of participants, “member” indicates a general member, and “leader” indicates a project leader. For example, five general members A, B, C, D, and E participate in the relevant exchange space for “SW1.1 development”. Four general members, A, D, E, and G, and F being the leader of the project participate in the relevant exchange space for “SW1.4 development”.

Here, with the procedure illustrated in FIG. 4, the weight value of each participant is calculated, and participant candidates for a new exchange space “SW1.5 development” are obtained. Here, it is assumed that the reliability of each participant is calculated as follows. Firstly, the weight value assigned to each relevant exchange space is set as the weight value of each participant in the relevant exchange space. For each participant, the value obtained by adding the weight values in all relevant exchange spaces in which the participant participate is set as the reliability of the participant.

In the example illustrated in FIG. 5, the participant A participates in all the relevant exchange spaces for version 1.1 to version 1.4, and thus the reliability is “3.0 (=0.6+0.7+0.8+0.9)”. Similarly, the participant B participates in the relevant exchange space for version 1.1 to version 1.3, and thus the reliability is “2.1 (=0.6+0.7+0.8)”. The participant C participates only in the relevant exchange space for version 1.1, and thus the reliability is “0.6”. The participant D participates in all the relevant exchange spaces for version 1.1 to version 1.4, and thus the reliability is “3.0 (=0.6+0.7+0.8+0.9)”. The participant E participates in the relevant exchange spaces for version 1.1, version 1.2, and version 1.4, and thus the reliability is “2.2 (=0.6+0.7+0.9)”. The participant F participates in the relevant exchange space for version 1.2, as a general member, and participates in the relevant exchange spaces for version 1.3 and version 1.4, as the leader of the project. Thus, the reliability as the general member is “0.7”, and the reliability as the leader is “1.7 (=0.8+0.9)”. The participant G participates only in the relevant exchange space for version 1.4, and thus the reliability is “0.9”.

In the above case, in a case where the threshold value for determining participant candidates for the new exchange space is set to “1.0”, the reliabilities of the participants A, B, D, E and the participant F as the project leader exceeds the threshold value. Thus, these participants are set as the participant candidates for the new exchange space. The participant F is set as the participant candidate as the leader. In the above example, the reliability of the participant F as the general member is “0.7”, which is smaller than the threshold value. However, in a case where the participant F is also participating in the relevant exchange space for version 1.1, the reliability becomes “1.3 (=0.6+0.7)” and exceeds the threshold value. In this case, in S407 of FIG. 4, the reliability as the general member and the reliability as the project leader are compared to each other, and the value of the reliability as the project leader is larger. Thus, the participant F is set as the participant candidate for the new exchange space, as the project leader.

Next, a specific example in which weighting is performed on a participant in accordance with the activity status in the exchange space will be described. Exchange activities such as transmission and reception of messages and data are performed in the exchange space. Thus, the weight value may be assigned to each participant in accordance with whether or not a message is posted, the number of times of posting the message, whether or not an action such as uploading of a data file or viewing of the uploaded data file is performed, and the number of times of performing the action.

FIG. 6 is a diagram illustrating a scene in which messages are transmitted and received in the exchange space. FIG. 6 illustrates an example of a UI screen for exchanging messages in the relevant exchange space for version 1.1. It is assumed that the participants A, B, C, D, and E participate in this relevant exchange space based on FIG. 5. Messages posted by the participants A, C, and E (displayed as “speakers” in FIG. 6) are displayed on a UI screen 171 illustrated in FIG. 6. It is assumed that a data file 171a (file of “functional specification draft”) is attached to the posted message of the participant A. The data file 171a uploaded to the exchange space by being attached to the message is shared by the participants of the exchange space, and thus may be viewed by each of the participants.

Here, it is assumed that the weight values are assigned to the types of exchange activities as follows, and the weight value assigned to each activity is added in accordance with the activity performed by the participant in the exchange space.
Message is posted.: Weight value “0.7”
Data file is uploaded.: Weight value “0.5”
Uploaded data file is viewed.: Weight value “0.5”

It is assumed that the data file 171a uploaded by the participant A is viewed by the participants B and C. In a case where the data file is viewed, the weight value of the participant A becomes “1.2” in total of the weight value “0.7” by posting the message and the weight value “0.5” by uploading the data file 171a. The weight value of the participant B is the weight value “0.5” by viewing the data file 171a. The weight value of the participant C is “1.2” in total of the weight value “0.7” for posting the message and the weight value “0.5” for viewing the data file 171a. The weight value of the participant D is “0” because no message is posted and no data file is uploaded or viewed. The weight value of the participant E is the weight value “0.7” by posting the message. The weight values are added to the weight value (in the example in FIG. 6, the weight value “0.6” because the relevant exchange space is the relevant exchange space for version 1.1) (described with reference to FIG. 5) based on the relevant exchange space in which each participant participate. Accordingly, the activity status of the participants in each relevant exchange space is reflected in selection of the participant candidate for the new exchange space.

A specific example of performing weighting based on the attributes of the relevant exchange space will be described. Even in a case where the relevant exchange spaces have the identical subject, it is considered that the importance of an exchange activity on the subject may vary depending on the attributes of each relevant exchange space. For example, in the software development project described with reference to FIG. 5, items to which the priority is given in development (referred to as “priority items” below) may vary depending on the version. In this case, the members required to carry out the project may vary depending on the priority items. Thus, the priority item in the development project is set as one of the attributes of the relevant exchange space corresponding to the development project. Then, it is considered that the similarity between the priority item of the development project for each version and the priority item of the development project corresponding to the new exchange space may be reflected in the weight value of the relevant exchange space corresponding to the development project of each version.

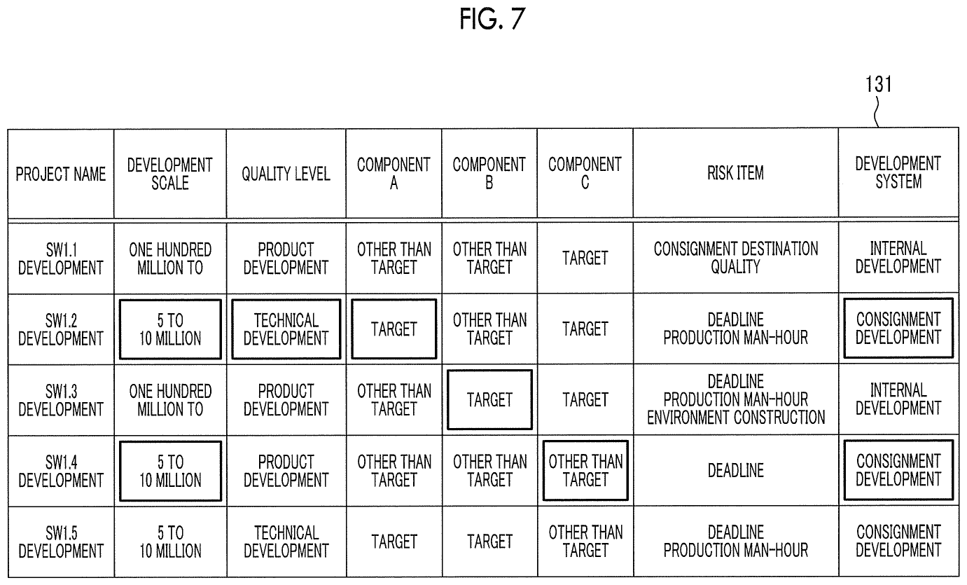

FIG. 7 is a diagram illustrating an example of priority items of the development project for each version illustrated in FIG. 5. In a list 131 illustrated in FIG. 7, information on items of “development scale”, “quality level”, “component A”, “component B”, “component C”, “risk item”, and “development system” is recorded for each development project of each version indicated by “project name”. In the example, among contents of the items, a weight value “0.25” is assigned to the item having a content that coincides with the content of the corresponding item of a development project of “SW1.5 development” corresponding to a new exchange space. Then, the total of weight values corresponding to the number of coinciding items is added to the weight value of a relevant exchange space corresponding to the development project.

In the example illustrated in FIG. 7, the content of each item in the development project of “SW1.5 development” corresponding to the new exchange space is compared with the content of each item in the development project of each other version. In a case where the contents are compared with each other, in the development project of “SW1.1 development”, there is no item having a content which coincides with the content of the item in the development project of “SW1.5 development”. Thus, there is no addition to the weight value of the relevant exchange space corresponding to the development project of “SW1.5 development”.

In the development project of “SW1.2 development”, the contents of four items (items indicated by thick frames) coincide with the contents of the items in the development project of “SW1.5 development”. Thus, the value “1.00 (=0.25×4)” is added to the weight value of the relevant exchange space corresponding to the development project of “SW1.2 development”.

In the development project of “SW1.3 development”, the content of one item (item indicated by a thick frame) coincides with the contents of the items in the development project of “SW1.5 development”. Thus, the value “0.25 (=0.25×1)” is added to the weight value of the relevant exchange space corresponding to the development project of “SW1.3 development”.

In the development project of “SW1.4 development”, the contents of three items (items indicated by thick frames) coincide with the contents of the items in the development project of “SW1.5 development”. Thus, the value “0.75 (=0.25×3)” is added to the weight value of the relevant exchange space corresponding to the development project of “SW1.4 development”.

As in the example described with reference to FIGS. 6 and 7, the value based on the activity status of each participant in each relevant exchange space and the difference in the attributes of the relevant exchange space is added to the weight value of the relevant exchange space or the weight value of each participant, and thereby the activity status or the difference in the attributes may be reflected in the reliability of each participant. In this manner, differing from a case where a new exchange space is simply created by duplicating a template prepared in advance or an existing exchange space, a participant candidate that matches the actual conditions of the new exchange space may be selected, and setting of the new exchange space may be supported.

### Examples of UI Screen

Next, a UI screen generated by the UI control function 170 of the server 100 and displayed on the display device 220 of the terminal apparatus 200 in a case where a new exchange space is created will be described. In a case of creating a new exchange space, the server 100 supports the setting of the exchange space created in accordance with the actual conditions of the new exchange space.

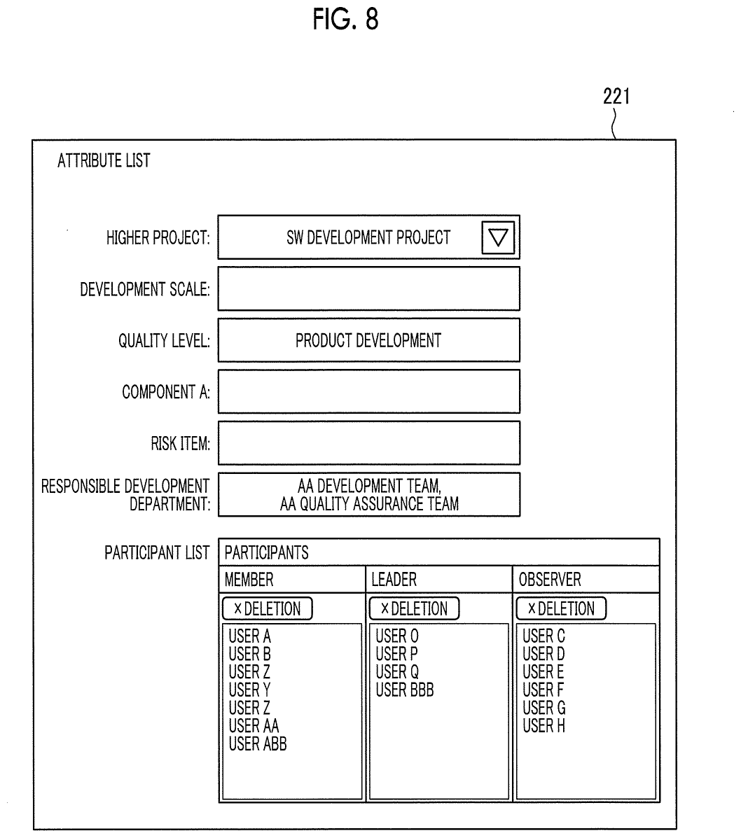

FIG. 8 is a diagram illustrating an example of a screen for presenting attributes of a template of a new exchange space. In a case where a new exchange space is created using a template, firstly, a presentation screen 221 for presenting information on the template is displayed on the display device 220 in the terminal apparatus 200, as a UI screen. The attributes of the template (or an exchange space used as the template) are displayed on the presentation screen 221 illustrated in FIG. 8. In the attribute “higher project”, the subject of the exchange space (“SW development project” in the example illustrated in FIG. 8) is displayed. In addition, participants are listed for each role such as “member”, “leader”, and “observer” as one of the attributes, along with the items illustrated in FIG. 7.

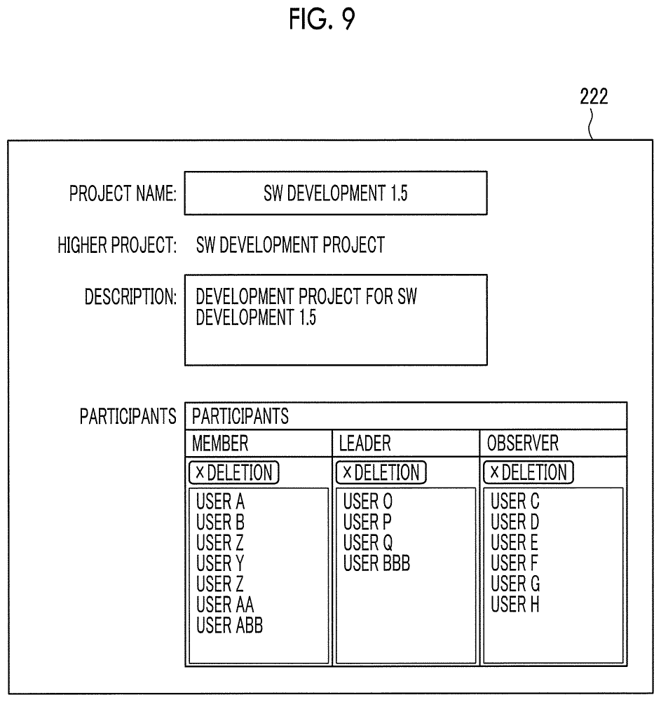

FIG. 9 is a diagram illustrating an example of a screen for presenting initial information of a new generated exchange space. On a presentation screen 222 illustrated in FIG. 9, the project name and the higher project are displayed, and the description of a development project corresponding to the new exchange space is displayed. This description is initially displayed by, for example, a fixed sentence quoting a project name or the like. The description may be input or edited by an input operation of a user. A list of participant candidates for the new exchange space is displayed on the presentation screen 222 illustrated in FIG. 9. The information on the participants illustrated in FIG. 8 is duplicated in the list of participant candidates. In a case where a user intends to change a participant in a new exchange space, the user performs a change operation on the presentation screen 222 with the input device 230 in the terminal apparatus 200. In a case where there is no problem in the presentation content (presentation content after the operation in a case where the change operation has been performed) of the presentation screen 222, the user registers the new exchange space in the server 100 and starts the use.

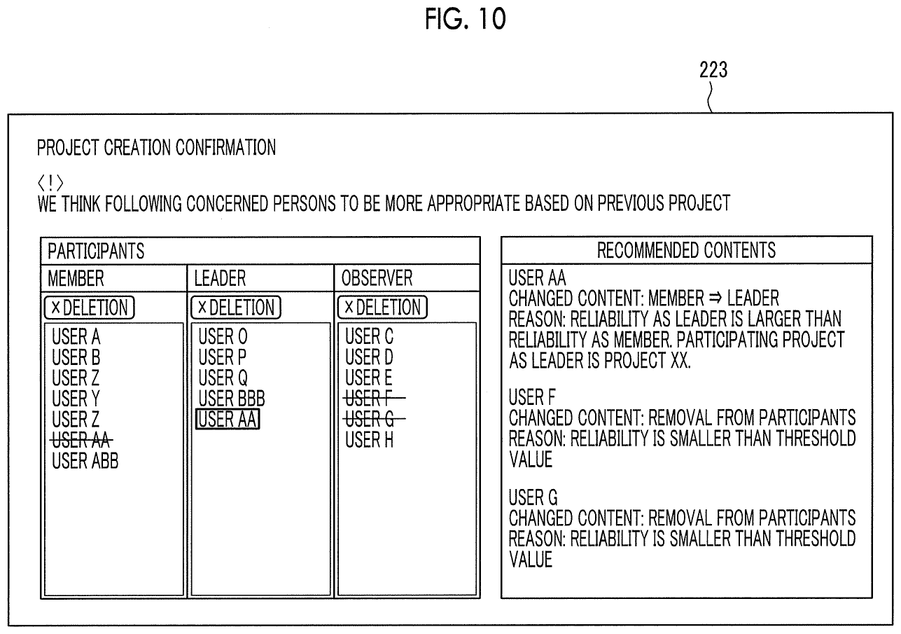

FIG. 10 is a diagram illustrating an example of a screen for recommending the participant candidate in a new exchange space. In a case where a registration operation of a new exchange space is performed, and there is a difference between the participant candidates in the initial information illustrated in FIG. 9 and the participant candidates specified by the participant setting function 140 of the server 100, the server 100 recommends, to the user, the participant candidate specified by the server 100 with a recommendation screen 223 as illustrated in FIG. 10. On the recommendation screen 223 illustrated in FIG. 10, among the candidates illustrated in the list of participant candidates displayed on the presentation screen 222 in FIG. 9, a deletion line is displayed for the candidate who is not included in the participant candidates specified by the participant setting function 140. The candidate who is a participant candidate specified by the participant setting function 140 and is not shown in the list of participant candidates displayed on the presentation screen 222 in FIG. 9 is highlighted (displayed with being enclosed by a frame line in FIG. 10). For example, regarding the participant candidates for “member”, a deletion line is displayed for a participant candidate “user AA”. Regarding the participant candidates for “leader”, the participant candidate “user AA” added in FIG. 10 is highlighted. Regarding the participant candidate for “observer”, a deletion line is displayed for participant candidates “user F” and “user G”. In the example illustrated in FIG. 10, the reason for deleting and adding the participant candidate is illustrated as the “recommended contents”. The reason for deleting and adding the participant candidate is generated by applying a fixed sentence to a target participant candidates, and the fixed sentence is prepared in advance based on, for example, the condition for adding a weight value to each relevant exchange space or each participant, and the condition for determining the participant candidate based on the reliability. In a case where the user needs to change the participant for the new exchange space by referring to the displays, the user returns to the presentation screen 222 in FIG. 9 and performs an operation of changing the participant.

In the example illustrated in FIGS. 8 to 10, in a case where the new exchange space is created, firstly, a participant candidate for the new exchange space is set based on the template. In a case where the user performs a registration operation of the new exchange space, the participant candidate based on the relevant exchange space is recommended with the recommendation screen 223 for the participant candidate. Thus, it is possible to urge the user to examine the participants in a case of creating a new exchange space. On the other hand, in the state of the initial information illustrated in FIG. 9, the participant candidate recommended based on the relevant exchange space may be presented.

Although the exemplary embodiment of the present invention have been described above, the technical scope of the present invention is not limited to the above exemplary embodiments. For example, in the above exemplary embodiment, an example in which the participant candidate for a new exchange space is specified based on the participants in the relevant exchange space, as support for setting the new exchange space, is described. On the other hand, in this exemplary embodiment, weighting is performed on the relevant exchange space based on a relation with a new exchange space, and the setting of each relevant exchange space is reflected in the setting of the new exchange space by adding the weight value assigned to each relevant exchange space. In this manner, the exemplary embodiment may be applied even to the setting of the new exchange space other than the participant candidate.

The method of assigning the weight value and the method of calculating the reliability, which have been described in the application example are just examples, and various methods that may reflect the weighting performed on the relevant exchange space to the setting of the new exchange space may be used. The configurations of the UI screens illustrated in FIGS. 8 to 10 are just examples, and the configurations are not limited to configurations illustrated in FIGS. 8 to 10. In addition, various changes and substitutions of configurations that do not depart from the scope of the technical idea of the present invention are included in the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to
create and manage an exchange space in which a post of a communication message is received and accumulated, and manage relation information indicating a relation between the exchange spaces, and
in a case where a new exchange space is created, specify a relevant exchange space having a specific relation with the new exchange space among existing exchange spaces, perform weighting on setting information of the relevant exchange space based on the relation between the relevant exchange space and the new exchange space, and set the new exchange space based on the weighted setting information of each relevant exchange space.

2. The information processing system according to claim 1,
wherein the processor is configured to specify an exchange space created with a matter identical to a matter of the new exchange space as a subject among the existing exchange spaces, as the relevant exchange space.

3. The information processing system according to claim 2,
wherein the processor is configured to perform weighting based on an order of creating the relevant exchange space such that a greater weight is assigned to a newer relevant exchange space.

4. The information processing system according to claim 1,
wherein the processor is configured to specify, as the setting information, a participant candidate of the new exchange space and an attribute of the participant candidate based on a participant of the relevant exchange space and an attribute of the participant.

5. The information processing system according to claim 4,
wherein the processor is configured to reflect an activity status of the participant in the relevant exchange space to the weighting on the participant as the setting information.

6. The information processing system according to claim 5,
wherein the processor is configured to assign a greater weight value to the participant as the number of posted communication messages of the participant in the relevant exchange space increases.

7. The information processing system according to claim 5,
wherein the processor is configured to assign a greater weight value to the participant as the number of times of viewing a data file shared with the participant in the relevant exchange space increases.

8. The information processing system according to claim 1,
wherein the processor is configured to specify an exchange space created by using an identical template among the existing exchange spaces, as the relevant exchange space.

9. The information processing system according to claim 8,
wherein the processor is configured to specify an exchange space created by using the existing identical exchange space among the existing exchange spaces, as the relevant exchange space.

10. A non-transitory computer readable medium storing a program causing a computer to execute a process, the process comprising:
creating and managing an exchange space in which a post of a communication message is received and accumulated, and managing relation information indicating a relation between the exchange spaces; and
in a case where a new exchange space is created, specifying a relevant exchange space having a specific relation with the new exchange space among existing exchange spaces, performing weighting on setting information of the relevant exchange space based on the relation between the relevant exchange space and the new exchange space, and setting the new exchange space based on the weighted setting information of each relevant exchange space.
